(19) United States
(12) Patent Application Publication
(10) Pub. No.: US 2015/0220703 A1
(43) Pub. Date: Aug. 6, 2015

(54) SYSTEMS AND METHODS FOR PROCESSING HOUSE CALLS

(71) Applicant: 1910852 Ontario Inc., Toronto (CA)

(72) Inventors: Bastian Friedrich Noffer, Moenchengladbach (DE); Hendrik Hermann Erich Stapel, Hueckelhoven (DE); David Fabian Kaup, Moenchengladbach (DE); Timothy Petrou, Toronto (CA)

(73) Assignee: 1910852 Ontario Inc., Toronto (CA)

(21) Appl. No.: 14/169,391

(22) Filed: Jan. 31, 2014

(51) Int. Cl. G06F 19/00

(52) U.S. Cl. CPC G06F 19/3481; G06F 19/3418; G06Q 40/08

(57) ABSTRACT

Systems and methods for scheduling and processing house calls between a plurality of patients and a plurality of practitioners. The systems and methods use a client-server architecture, removing the need for a call center to perform patient intake and house call scheduling, and improving workflows by allowing practitioners to view and select patient requests for house calls. Other embodiments relate to systems and methods for generating claim codes and diagnostic codes from a set of practitioner notes, and transmitting them to a third party for processing.

### FIELD

The described embodiments relate to processing a house call between a plurality of practitioners and a plurality of patients, and in particular, to systems and methods for scheduling a house call and generating claim and diagnostic information corresponding to a house call.

### BACKGROUND

House call services typically use call centers as an intake point for receiving a patient request, recording patient information and coordinating with practitioners on staff to schedule a house call for the patient (also referred to herein as a “visit”). Call centers may not verify patient information such as patient name, phone number, address, health insurance number, or medical information during intake procedures, and this information would need to be checked and recorded by a practitioner conducting the house call. Practitioners conducting the house call typically use a notepad to prepare notes containing diagnostic codes or claim codes associated with the house call. Practitioners then submit claim codes or diagnostic codes to a third party billing service, health insurance provider or government department, for payment or updating patient medical information (e.g. patient medical records, or patient prescriptions).

Errors in recording patient information at the call center or illegible notes taken by a practitioner conducting the house call may frustrate the process in numerous ways. For example, recording an address incorrectly may cause delays if a practitioner is dispatched to the wrong location, and illegible practitioner notes may result in claim submissions being rejected by a health insurance provider. Additionally, errors in scheduling and coordinating practitioners may lead to double bookings.

### SUMMARY

In a first aspect, there is provided a method for scheduling a visit between a plurality of practitioners and a plurality of patients over a communications network, the method comprising: receiving a first appointment request at at least one server from a patient communication device for validation; validating the first appointment request at the at least one server to generate a first validated request; storing, at the at least one server, the first validated request in a pool comprising a plurality of validated requests; transmitting the first validated request to a practitioner communication device; receiving a selected request corresponding to one of the plurality of validated requests from the practitioner communication device; removing the selected request from the plurality of validated requests at the at least one server; and scheduling the visit on a schedule of the practitioner for the selected request.

In some cases, the at least one server transmits an appointment indication to the one of the plurality of patient communication devices.

In some cases, the first request comprises at least one of a plurality of request attributes. In some cases, the request attributes comprise patient health insurance information, patient biographical information, patient geo-location information, or patient medical information.

In some cases, the schedule is transmitted to the practitioner communication device.

In some cases, the selected request is based on the at least one of a plurality of request attributes.

In another broad aspect, there is provided a method for processing claims for a plurality of patients over a communication network, the method comprising: receiving a set of practitioner notes at at least one server from a practitioner communication device; extracting a plurality of keywords from the set of practitioner notes; correlating the keywords against a plurality of known keywords stored in a database; generating one or more visit attributes based on the correlation; and transmitting the one or more visit attributes to the at least one server.

In some cases, the set of practitioner notes correspond to one of a plurality of patient visits.

In some cases, the visit attributes comprise at least one claim code, at least one diagnostic code, at least one prescription, or at least one patient instruction.

In another broad aspect, there is provided a system for scheduling visits between a plurality of practitioners and a plurality of patients over a communications network, the system comprising: a patient communication device configured to generate a first appointment request; a practitioner communication device; at least one server configured to: receive the first appointment request from the patient communication device for validation; validate the first appointment request to generate a first validated request; store the first validated request in a pool comprising a plurality of validated requests; transmit the first validated request to the practitioner communication device; receive a selected request corresponding to one of the plurality of validated requests from the practitioner communication device; remove the selected request from the plurality of validated requests; and schedule the visit on a schedule of the practitioner for the selected request.

In another broad aspect, there is provided a system for processing claims for a plurality of patients over a communication network, the method comprising: a practitioner communication device; at least one server configured to: receive a set of practitioner notes from the practitioner communication device; extract a plurality of keywords from the set of practitioner notes; correlate the keywords against a plurality of known keywords stored in a database; generate one or more visit attributes based on the correlation; and transmit the one or more visit attributes.

### BRIEF DESCRIPTION OF THE DRAWINGS

A preferred embodiment of the present invention will now be described in detail with reference to the drawings, in which:

FIG. 1A is a simplified schematic diagram of a house call system according to an example embodiment;

FIG. 1B is a simplified schematic diagram of another house call system according to another example embodiment;

FIG. 2 is a simplified schematic diagram of a communication device for scheduling visits between a practitioner and a plurality of patients according to an example embodiment;

FIG. 3 is a schematic diagram of an implementation of the house call system of FIGS. 1A and 1B;

FIG. 4A is a process flow diagram for a patient communication device according to an example embodiment;

FIG. 4B is a process flow diagram for a practitioner communication device according to an example embodiment; and

FIG. 5 is a process flow diagram for a management server according to an example embodiment.

### DESCRIPTION OF EXAMPLE EMBODIMENTS

“House call services” typically involve a call center where patients are able to call in and request a visit from a doctor or other health care practitioner. The call center acts as a central coordination point for scheduling patients with doctors who are working shifts through the service. Although the call center will act also as an intake point for gathering patient information, this information is not verified and needs to be checked by the doctor upon arrival at the patient's location.

A doctor who conducts a house call records notes and insurance claim codes on a notepad. The doctor also needs to record patient information on the same notepad so that information can be transmitted to the appropriate parties via a third party billing service or personally. Often times, handwriting errors or illegibility of notes frustrates the process of claim submission requiring phone calls to the patient in an attempt to obtain correct information. Finally, these handwritten notes are not conducive to maintaining records of the visits and do not integrate with electronic health record (EHR) solutions.

The described embodiments reduce the administrative burden of maintaining a call center and coordinating doctors from a central location. The described embodiments can also be integrated with current systems to create efficiencies in preexisting work flows. Leveraging geo-location technologies and real time information, practitioners can be directed to underserviced areas within predefined boundaries, while eliminating the possibility that practitioners will be double booked to see the same patient.

Moreover, the system can anticipate local traffic conditions or modes of transportation and provide the doctor with instructions on how to arrive at the next patient's location in the shortest amount of time. Therefore, call centers no longer have a need to continuously update doctors already out seeing patients with new patient lists or directions.

By digitizing the information collection aspect and building in a robust, secure, and dedicated communication network the described system enables better record storage, analytics, and more efficient patient care. If a patient requires a follow up visit, the described system allows for a “telemedicine” solution to allow practitioners to conduct a follow up remotely. If a patient requires more urgent attention, she may have the option to contact the practitioner who had seen her via a priority channel thereby potentially avoiding extra trips to hospitals or urgent care centers where the patient's issue is manageable with simple instructions. All information is stored on secure servers where it may be accessed at any point in the future or integrated with digital patient files at the general practitioner's office (EMR) or the location of a central health record (EHR).

At least some of the systems and methods described herein include processing and scheduling of house calls using a client-server architecture, which may remove the need for a call center to perform patient intake and house call scheduling. At least some of the systems and methods described herein include receiving requests at a management server from a communication device of a patient, validating the request at the management server, displaying the request on a communication device of a practitioner on staff to decide whether to select the request, and notifying the patient of the selected request. This approach allows practitioners on a staff to view requests prior to or during a shift, select requests based on a number of criteria including the patient's geographical location or medical history, or respond to a follow-up request from a patient.

At least some of the systems and methods described herein include generating diagnostic codes and claim codes from practitioner notes received at the management server from a communication device of a practitioner. Practitioner notes can be parsed at the management server and compared to keywords contained in a database to generate diagnostic codes and claim codes. These codes can be transmitted to an external server, which may include for example, billing services, health insurance providers, or government departments. This approach provides a more efficient process for generating diagnostic codes and claim codes for practitioners, as well as for generating reports corresponding to a practitioner's shift activity. Reports may include, for example, total number of claims billed per time interval, total claim value billed per time interval, total number of patients seen per time interval, etc.

At least some of the systems and methods described herein include facilitating a patient to: log in to a web portal or mobile application and enter biographical information and information about the patient's condition, receive a notification with an estimated arrival time once the practitioner is en route, receive post-visit instructions from the practitioner through an electronic message, and enable the patient to contact the practitioner directly, for example, in the case of an emergency.

At least some of the systems and methods described herein facilitate a practitioner to log in to a web portal or mobile application at the start of a shift, view an interface that displays patient requests geographically, and select patient requests based on the patient's geographical location, biographical location, or other criteria, such as patient biographical information or medical condition.

At least some of the systems and methods described herein include the upload of patient information to a practitioner's mobile device and making the information viewable through, for example, a mobile application.

At least some of the systems and methods described herein facilitate a practitioner to record notes associated with a patient visit using, for example, a scribe pen, dictation, or text. Notes can then be transmitted to the management server via a mobile device of the practitioner.

At least some of the systems and methods described herein include the transmission of electronic prescriptions to a patient's pharmacy from a mobile device of the practitioner.

It will be appreciated that numerous specific details are set forth in order to provide a thorough understanding of the example embodiments described herein.

However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein. Where considered appropriate, for simplicity and clarity of illustration, reference numerals may be repeated among the figures to indicate corresponding or analogous elements or steps.

The embodiments of the systems and methods described herein may be implemented in hardware or software, or a combination of both. However, preferably, these embodiments are implemented in computer programs executing on programmable computers each comprising at least one module component which comprises at least one processor (e.g. a microprocessor), a data storage system (including volatile and non-volatile memory and/or storage elements), at least one input device, and at least one output device. For example and without limitation, the programmable computers (referred to below as computing devices) may be a computer server, personal computer, laptop, personal data assistant, cellular telephone, smart-phone device, tablet computer, and/or wireless device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

Further, although method or process acts, algorithms or the like may be described (in the disclosure and/or in the claims) in a sequential order, such processes, methods and algorithms may be configured to work in alternate orders. In other words, any sequence or order of acts that may be described does not necessarily indicate a requirement that the acts be performed in that order. The acts of processes described herein may be performed in any order that is practical. Further, some acts may be performed simultaneously.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device or article.

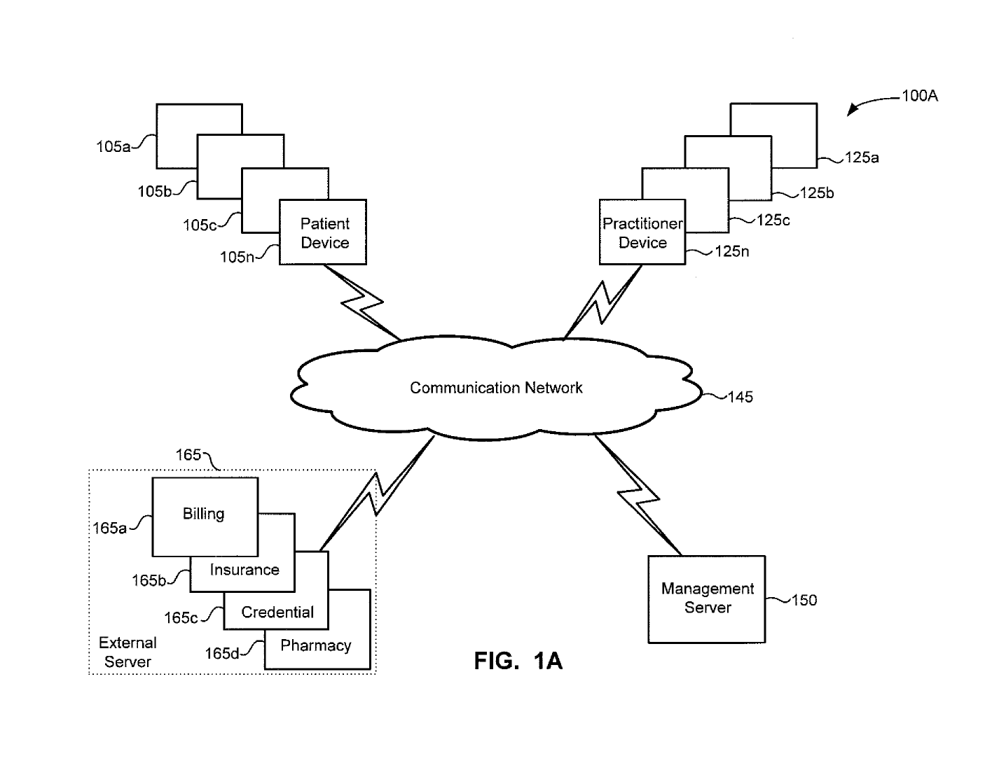

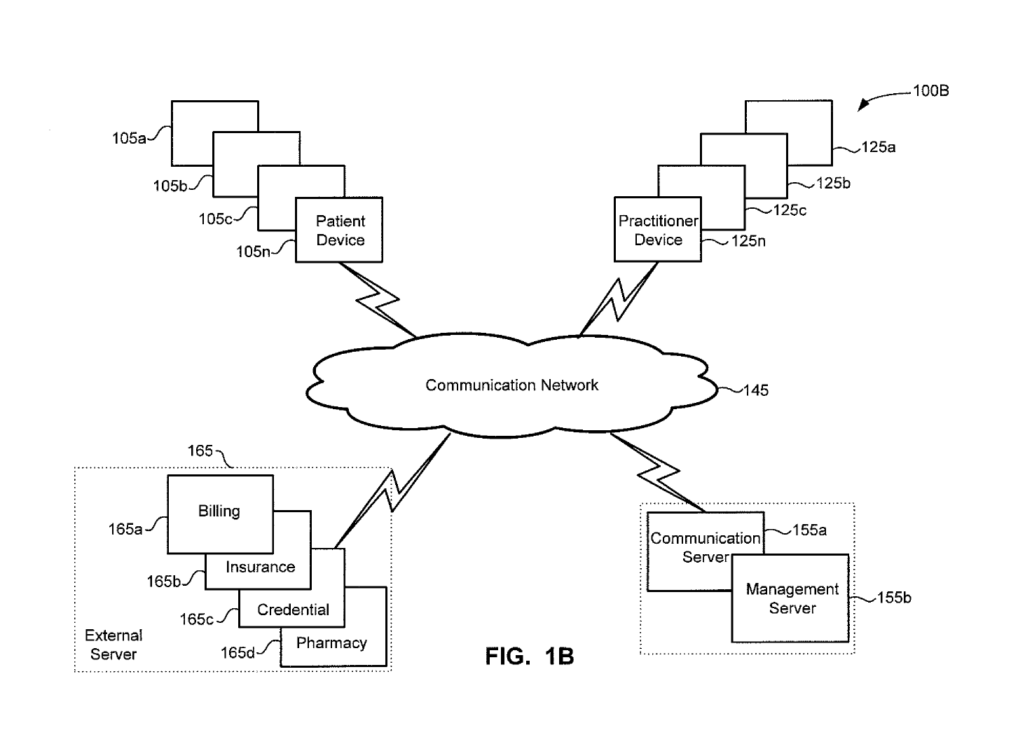

Reference is first made to FIG. 1A, which illustrates an example system 100a for scheduling visits between a plurality of patients and a plurality of practitioners. System 100a comprises a plurality of patient communication devices, 105a, 105b, 105c, and 105n, a plurality of practitioner communication devices 125a, 125b, 125c, and 125n. Device 105a represents a first patient communication device, device 105b represents a second patient communication device, device 105c represents a third patient communication device, and device 105n represents an n^{th} patient communication device. Similarly, device 125a represents a first practitioner communication device, device 125b represents a second practitioner communication device, device 125c represents a third practitioner communication device, and 125n represents an n^{th} practitioner communication device. Examples of patient and practitioner communication devices may include any electronic device capable of communication over a communications network, such as, cellular phones, smart phones, tablets, wireless organizers, personal digital assistants, computers, laptops, Internet appliances and the like.

System 100a includes communication network 145, which may be implemented with various network technologies, such as wired or wireless distribution systems, fiber optic networks, satellite or extra-terrestrial systems, or any combination or hybrid thereof. Communication network 145 can include public (e.g., Internet) or private networks suitable for wired or wireless data communication.

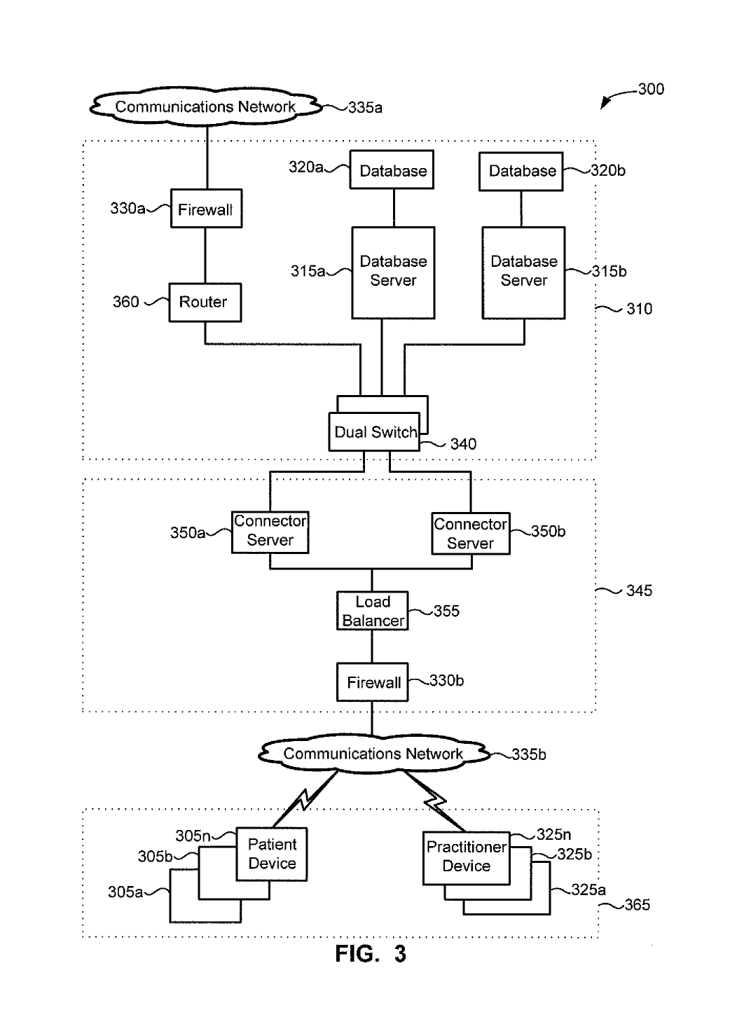

Management server 150 may include at least one computer server equipped with a processor and memory storing, for example, a database, schedule or file system and computer executable program code as described herein. Management server 150 typically acts as the primary interface between patient communication devices 105a-105n and practitioner communication devices 125a-125n, connecting to such devices via communication network 145. In this embodiment, management server 150 implements data core layer 310 and connector layer 345, as described with respect to FIG. 3 herein.

External server 165 may include one or more servers equipped with a processor and memory storing, for example, a database, schedule or file system and computer executable program code as described herein. In one example embodiment, external server 165 may include a billing server 165a for processing claims on behalf of practitioner to submit to a health insurance provider, a health insurance server 165b for processing claims received from a practitioner, a credential verification server 165c for verifying patient information contained in a request (e.g. health insurance number) and storing patient medical records, and a pharmacy server 165d for processing prescriptions. Management server 150 may connect to external server 165 directly (not shown) or via communication network 145.

Reference is next made to FIG. 1B, which illustrates another example embodiment of system 100b for scheduling visits between a plurality of patients and a plurality of practitioners. System 100b is generally analogous to system 100a of FIG. 1A, with the exception that management server 150 is replaced with at least one computer server, including communication server 155a, which is connected to management server 155b. In this embodiment, communication server 155a implements connector layer 345 as described with respect to FIG. 3 herein, while management server 150b implements data core layer 310.

Communication server 155a may act as the primary interface between patient communication devices 105a-105n and practitioner communication devices 125a-125n, connecting to such devices via communication network 145. For example, communication server may be configured to receive a patient request, encrypt information contained in the request using for example advanced encryption standard (AES), and transmit the encrypted request to management server 155b to validate the request at the management server 155b or via external server 165. If the request is validated, management server 155b is configured to store the request among a pool of validated requests and transmit the validated request to the communication server 155a for encryption and transmission to one or more practitioner communication devices 125.

Each of management server 150, management server 155b, and communication server 155a can include a plurality of software or hardware modules configured to carry out the actions described herein, including authentication modules for authenticating patients and practitioners, encryption modules for encrypting data transmitted to external server 165 or data transmitted between management server 155b and communication server 155a, scheduling modules for scheduling visits between patients and practitioners, and mapping modules for displaying geo-locations of patients and practitioners.

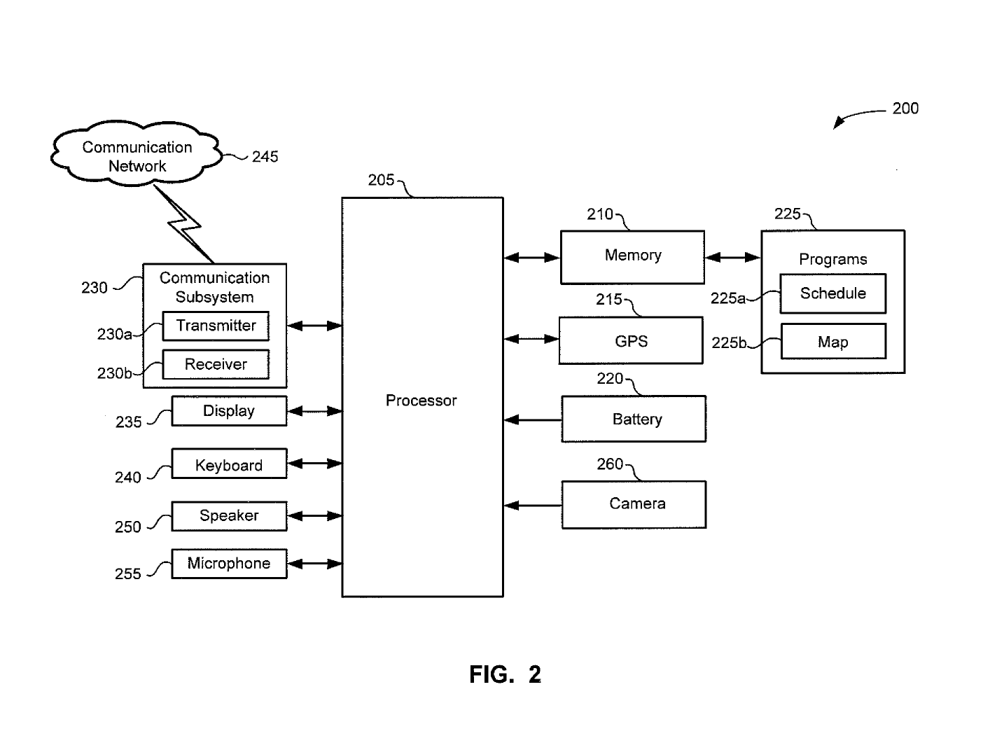

Reference is now made to FIG. 2, which illustrates the elements of an example communication device 200, of which practitioner devices 125a to 125n of FIGS. 1A and 1B may be implementations. Practitioner communication device 200 generally includes a number of components, in particular a processor 205, memory 210 and communication subsystem 230, and, depending on configuration, a GPS module 215, battery 220, display 235, keyboard 240, speaker 250, and microphone 255.

Communication subsystem 230 comprises a radio transmitter 230a and receiver 230b to send and receive data, respectively, and may comprise an antenna (not shown) for connecting to communication network 245.

Memory 210 may store computer executable code in the form of programs or modules 225, including a schedule module 225a, map module 225b, and operating system software or message modules (not shown) that allow the user of the communication device to send and receive electronic messages, text messages, or voice messages.

GPS module 215 is a receiver for the Global Positioning System (or equivalent, such as GLONASS or Galileo), and is configured to provide navigation and geographical positioning data to map module 225b.

Processor 205 executes the computer executable code stored in memory 210 and generally interacts with the display 235, keyboard 240, speaker 250, and microphone 255 to provide communication related functions, such as entering a text message for delivery over the communication network 245 or program functions such as displaying the user's geographical position on map module 225b. Keyboard 240 may comprise, for example, a physical buttons or a touchscreen keyboard for entering text. Display 235 may comprise a liquid crystal display (LCD), organic light emitting diode (OLED), or the like for displaying information.

Speaker 250 may generate audio signals, for example, when the mobile device is used as a telephone handset. Microphone 255 may, for example, capture audio signals when the mobile device is used to record dictation or used to convert audio signals to electrical signals when the device is used as a telephone handset. Battery 220 may comprise, for example, a lithium ion battery for providing power to the mobile device. Camera 260 may be used to take pictures or to record video on the mobile device.

In some embodiments, a practitioner communication device may be used to validate patient identification by: taking a picture of a patient identification using camera 260 and transmitting the patient identification picture to the management server for parsing. The parsed patient identification may be transmitted by the management server to an external server (e.g. government-managed server) for validation. Upon validation, and the practitioner communication device may receive an identification validation notice at the practitioner communication device from the external server.

Reference is next made to FIG. 3, which illustrates an example system for processing house calls. System 300 may comprise three layers: a first, data core layer 310; a second, connector layer 345; and a third, endpoints layer 365.

Data core layer 310 stores patient and practitioner data, processes all incoming and outgoing data and communicates with external server 165 through a secure communications link over communications network 335a, for example, to transmit patient medical information to a government department, or to submit claims associated with a patient visit to an insurance provider. Communications network 335a may be a dedicated private network, or a virtual private network configured over top of a general communications network, such as communication network 145 of FIGS. 1A and 1B. In some embodiments, external server 165 interacts with data core layer 310 to update claim status, generate reports, or notify staff of errors in submissions.

In the illustrated example, data core layer 310 includes database servers 315a and 315b, databases 320a and 320b, router 360, firewall 330a, and dual switch 340. Database servers 315a and 315b may be configured to provide databases 320a and 320b using, for example, Microsoft® SQL Server® or other suitable database management system for providing database infrastructure and data security features, including database encryption and secured authentication.

Servers operating in the data core layer 310 are configured in a private or virtual private network and may access the Internet through a restricted router 360 and firewall 330a in order to protect confidential patient information, for example, patient medical records. Servers in the data core layer may be arranged in a cluster architecture to provide parallel processing and scalability.

Connector layer 345 comprises connector servers 350a and 350b for connecting endpoint devices, for example, patient and practitioner mobile devices 305a-305n and 325a-325n, respectively, to the data core layer 310. Generally, connector layer 345 serves to pre-process incoming or outgoing data to ensure that only validated data is passed to data core layer 310, thereby reducing errors during further processing of the collected data. Connector layer 345 may include a load balancer 355 for network efficiency, and firewall 330b for security. Additional security measures in connector layer 345 to protect confidential patient information include Transport Layer Security (TLS), which may include encryption algorithms such as Advanced Encryption Standard (AES), username-password login, security tokens and Internet protocol validation.

Connector layer 345 may perform pre-processing of data received from endpoints layer 365, for example, by analyzing the data received from the patient or practitioner communication devices and transmitting only validated data to the data core layer 310. This approach reduces errors during processing of collected data and minimizes storage of incorrect data in the data core layer 365.

In some cases, connector layer 345 may comprise a web application platform, such as ASP.NET, and provide application programming interfaces (APIs), modules and applications to carry out specific functions and interface with system 300.

For example, connector layer 345 may comprise an insurance provider module, which can be used to verify healthcare insurance information received from a patient. The patient healthcare insurance information can be verified with the insurance provider by the insurance provider module. If verification is unsuccessful, connector layer 345 may request the patient device to resubmit corrected information. Upon successful verification, the patient data in the data core layer may be created or updated.

Similarly, connector layer 345 may comprise a billing module, which can be used to automatically verify billing information submitted from practitioner devices against a schedule of benefits provided by the relevant health authority (e.g., government agency). If billing errors or anomalies are detected in the submission, the practitioner device may be notified and requested to resubmit corrected billing information. Upon successful verification of billing information, the practitioner and patient records may be updated in the data core layer.

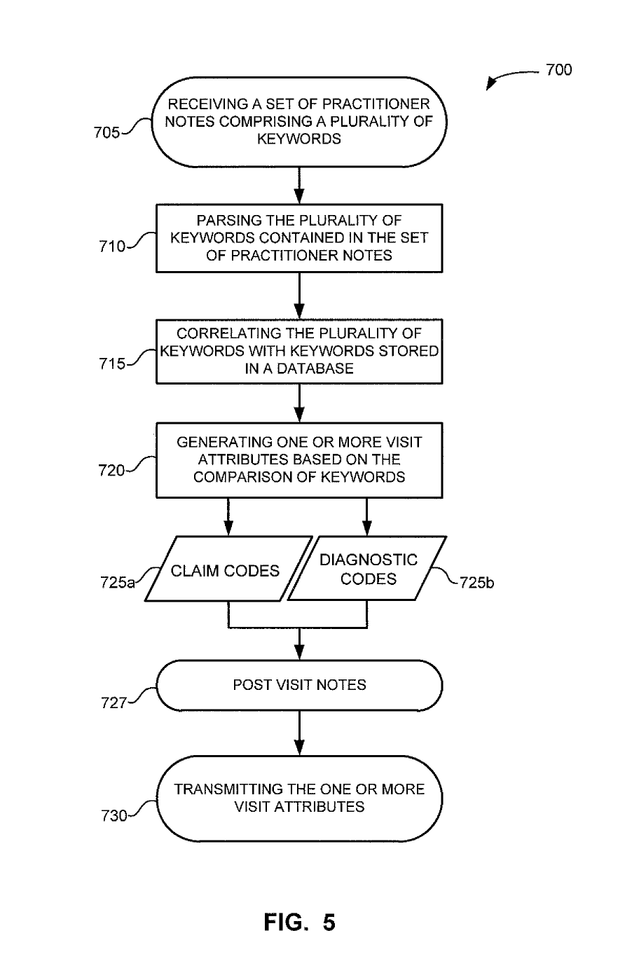

In some cases, connector layer 345 may comprise a text analytic abstraction layer module, which receives and analyzes practitioner notes to extract keywords, as described herein with respect to FIG. 5. In the case of voice or audio notes, the text analytic abstraction module may comprise a speech-to-text engine for transcribing notes. However, in some cases, the speech-to-text engine may be part of the practitioner device.

Endpoints layer 365 includes client applications such as, for example, a web application, mobile application, or desktop application, which may reside on patient and/or practitioner communication devices, 305n or 325n, respectively. Each client application connects to the connector layer 345 through a secure communications link over communications network 335b (e.g., communication network 145 of FIGS. 1A and 1B).

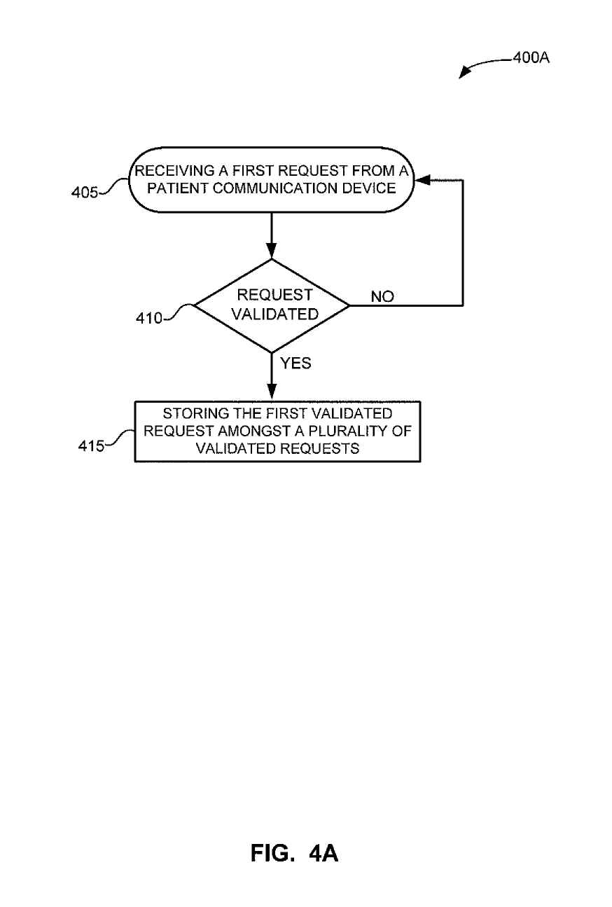

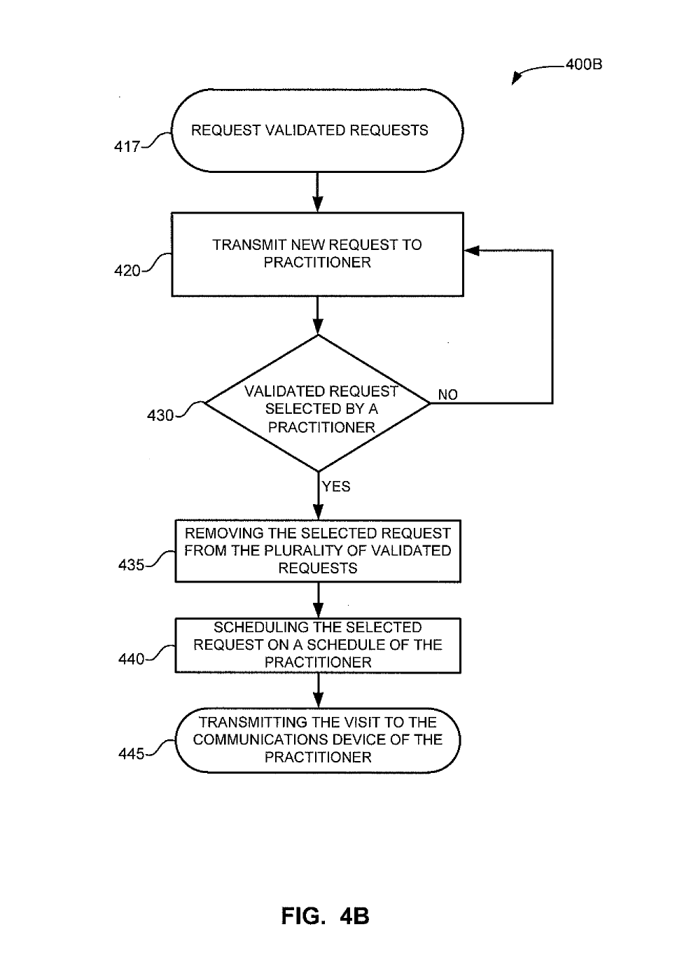

Reference is next made to FIG. 4A, which illustrates an example process flow 400A for validating a request from one or more of a plurality of patients and one or more of a plurality of practitioners. Flow 400 may be executed, for example, at management server 150 or communication server 155a working with management server 155b. For ease of exposition, the embodiments herein are described with reference to communication server 155a and management server 155b. In other embodiments, management server 150 may carry out all of flow 400.

At 405, communication server 155a receives a first appointment request from a patient communication device 105a. The first appointment request typically comprises one or more appointment request attributes, which may include one or more of the patient's biographical information (e.g., name, e-mail address, phone number, street address), health insurance number, biological information, geo-location (e.g., based on IP address or other data), patient medical information (e.g. medical history, medical condition, etc.), and type of visit requested. For example, a patient may request a follow-up visit from a practitioner that conducted a previous visit, request an emergency visit, or request a specific practitioner to conduct the visit. The appointment request attributes can be used to provide practitioners with flexibility in selecting requests in order to determine their own schedule. For example, a practitioner may select requests that correspond to a specific geographical location, to patients within a specific age group, or to patients with a particular medical condition.

To assist patients in filling in their location details through the Web Portal a so called geo-location database (GeolP) may be used. This database can help to pinpoint the user's location using the Internet Protocol (IP) address of the patient communication device. At 410, communication server 155a validates the first appointment request. Validating the first appointment request may comprise verifying the corresponding request attributes against a database stored on communication server 155a or management server 155b, or may comprise transmitting the request attributes to external server 165 for further verification. Request attributes may include a patient health insurance number, patient name, patient email address, or patient phone number, for example. To perform verification, communication server 155a may transmit request attributes to external server 165b to verify, e.g., that the patient's name corresponds to the patient's health insurance number provided in the first request. If the first appointment request is not validated, the patient may be prompted to correct any request attributes entered incorrectly at 410.

In some cases, communication server 155a may transmit the request attributes to external server 165 to verify the request attribute, for example, a patient health insurance number may be verified by health insurance server 165c. In other embodiments, communication server 155a may verify a request attribute with information stored locally on a database. Once the request attribute corresponding to the first appointment request is verified, communication server 155a forwards the appointment request to management server 155b, which creates a validated first request at 615, to be stored amongst a pool of validated requests.

In some cases, communication server 155a may verify a request attribute with information stored locally on a database.

At 415, management server 155b stores the validated request among a pool of validated requests.

Flow 400A may be executed in response to requests from a plurality of patients, to generate the plurality or pool of validated requests.

Referring now to FIG. 4B, there is illustrated an example process flow 400B for scheduling a visit between a plurality of patients and a plurality of practitioners. Flow 400B may be executed, for example, at management server 150 or management server 155b.

At 417, practitioner communication device requests one or more validated requests for review at the practitioner communication device. The request may be transmitted upon the practitioner executing a schedule module, for example.

At 420, the management server 155b retrieves a plurality of validated requests and selects at least a first validated request for transmission to the practitioner communication device.

As described, the first validated request may be transmitted in response to a query from the practitioner communication device, and may be selected based on the geographical proximity of the practitioner communication device to the patient location in the request, or based on the already-scheduled appointments for the practitioner communication device. For example, if a previously scheduled appointment is at a location in close proximity later in the day, it may be selected for review, even though the practitioner communication device is presently at a distant location.

In some cases, however, the first validated request may be transmitted immediately upon validation by the management server, and without the practitioner communication device requesting requests for review. This may occur, for example, in the case of an emergency request.

In general, management server 155b allows for practitioners to log in at any time to view the number of doctors currently operating in their area, patient wait time in their area, and the number of open tickets (or patients waiting to be seen). Through geo-location, the system automatically presents information relative to a predefined radius from the current location of the practitioner communication device. A practitioner is thus free to move about a territory and the management server 155b provides directions to whatever patient is next in the queue, or which the practitioner selects to visit next. Patients may be given priority status if they are experiencing a longer than usual wait time. This can be enabled by using GPS modules that are present in modern smartphones.

At 430, the management server 155b receives a selection indication from one of a plurality of practitioner communication devices 125a-125n that the first validated requested has been selected. A selected request indicates that a practitioner has chosen to visit the patient associated with the validated request. Optionally, the management server receives a rejection indication that the first validated request was rejected or otherwise not selected, in which case a further validated request may be selected from the plurality of validated requests and transmitted to the practitioner communication device.

Once the selection indication is received, the management server 155b removes the selected request from the pool of validated requests at 435.

At 440, the management server 155b adds the selected validated request to a schedule of the practitioner. At 445, management server 155b transmits the updated schedule to the practitioner communication device, and transmits relevant patient information for use by the practitioner. Likewise, management server 155b may transmit an appointment indication to the patient communication device 105a-105n corresponding to the appointment request. The appointment indication may contain an indication of the estimated time of arrival for the practitioner or a scheduled appointment time.

Optionally, a practitioner device may repeat flow 400B as many times as desired to populate a respective appointment schedule.

Reference is next made to FIG. 5, which illustrates an example process for generating claim codes and diagnostic codes corresponding to a visit. Flow 700 may be executed, for example, at management server 150 or communication server 155a working with management server 155b. For ease of exposition, the embodiments herein are described with reference to communication server 155a and management server 155b. In other embodiments, management server 150 may carry out all of flow 700.

At 705, communication server 155a receives a set of practitioner notes comprising a plurality of keywords from a practitioner communication device 125a-125n. Practitioner notes are generally transmitted from the practitioner communication device at the conclusion of a scheduled appointment. During the scheduled appointment, the practitioner notes may have been entered into the practitioner communication device using a suitable input device, such as microphone, keyboard or mouse, touchscreen or stylus. In some cases, the practitioner notes may have been entered by scanning or imaging handwritten notes using a camera of the practitioner communication device.

Communication server 155a parses the keywords contained in the practitioner notes at 710, for example using optical character recognition in the case of handwritten or scanned notes or voice recognition in the case of audio notes. The parsed keywords are analyzed and correlated against keywords stored locally in a database of management server 150 at 715.

At 720, communication server 155a generates one or more visit attributes corresponding to a visit, which is based on the correlation of keywords stored in the local database at communication server 155a, and the keywords parsed from the set of practitioner notes. The generated visit attributes are forwarded to management server 155b, where they are used to update patient and practitioner data.

Visit attributes may include, for example, claim codes 725a corresponding to claims for submission to a health insurance provider, third party billing service, or government department associated with providing health care services. Visit attributes may also include diagnostic codes 725b corresponding to a patient's medical record for submissions to a government department associated with providing health care services. Visit attributes may include a pharmaceutical prescription corresponding to a visit, or in some cases visit attributes may include post-visit instructions corresponding to a visit.

Optionally, at 727, post-visit instructions may be received from the practitioner communication device, which may include instructions for the patient, or which may be used to facilitate emergency contact feature at the patient communication device. The post-visit instructions may be transmitted to the patient communication device via a module on the patient communication device, via push notification, or optionally via e-mail or short message service (SMS).

The physician may elect to enable a dedicated communication channel for messages originating from the patient to the physician if desired. When the dedicated communication channel is enabled, an optional feature may be enabled at the patient communication device that opens a distress line to the practitioner. The practitioner may then receive a voice message or text message from the patient, alerting them to any change in condition. The practitioner can elect to contact the patient directly, via phone, video call, text message, e-mail or otherwise.

At 730, the one or more visit attributes and the post-visit instructions (if present) are transmitted by the communication server 155a or the management server 155b to the practitioner communication device 125 or to an external server (e.g., pharmacy).

In some cases, management server 155b generates a report providing claim codes and diagnostic codes corresponding to each visit conducting by a practitioner during a specific time period (e.g. during a shift). In some embodiments, management server 155b transmits claim codes or diagnostic codes to external server 165 for processing. For example, management server 155b may transmit diagnostic codes to government server 165c to update a patient's medical record, or management server 155b may transmit a prescription to pharmacy server 165c. In other embodiments, management server may transmit post-visit instructions to a patient communication device.

The present invention has been described here by way of example only. Various modification and variations may be made to these example embodiments without departing from the spirit and scope of the invention, which is limited only by the appended claims.

We claim:

1. A method for scheduling a visit between a plurality of practitioners and a plurality of patients over a communications network, the method comprising:
receiving a first appointment request at at least one server from a patient communication device for validation;
validating the first appointment request at the at least one server to generate a first validated request;
storing, at the at least one server, the first validated request in a pool comprising a plurality of validated requests;
transmitting the first validated request to a practitioner communication device;
receiving a selected request corresponding to one of the plurality of validated requests from the practitioner communication device;
removing the selected request from the plurality of validated requests at the at least one server; and
scheduling the visit on a schedule of the practitioner for the selected request.

2. The method of claim 1, wherein the at least one server transmits an appointment indication to the one of the plurality of patient communication devices.

3. The method of claim 1, wherein the first request comprises at least one of a plurality of request attributes.

4. The method of claim 1, wherein the schedule is transmitted to the practitioner communication device.

5. The method of claim 3, wherein the request attributes comprise patient health insurance information.

6. The method of claim 3, wherein the request attributes comprise patient biographical information.

7. The method of claim 3, wherein the request attributes comprise patient geo-location information.

8. The method of claim 3, wherein the request attributes comprise patient medical information.

9. The method of claim 3, wherein the selected request is based on the at least one of a plurality of request attributes.

10. A method for processing claims for a plurality of patients over a communication network, the method comprising:
receiving a set of practitioner notes at at least one server from a practitioner communication device;
extracting a plurality of keywords from the set of practitioner notes;
correlating the keywords against a plurality of known keywords stored in a database;
generating one or more visit attributes based on the correlation; and
transmitting the one or more visit attributes to the at least one server.

11. The method of claim 10, wherein the set of practitioner notes correspond to one of a plurality of patient visits.

12. The method of claim 10, wherein the visit attributes comprise at least one claim code.

13. The method of claim 10, wherein the visit attributes comprise at least one diagnostic code.

14. The method of claim 10, wherein the visit attributes comprise at least one prescription.

15. The method of claim 10, wherein the visit attributes comprise at least one patient instruction.

16. A system for scheduling visits between a plurality of practitioners and a plurality of patients over a communications network, the system comprising:
a patient communication device configured to generate a first appointment request;
a practitioner communication device;
a at least one server configured to:
receive the first appointment request from the patient communication device for validation;
validate the first appointment request to generate a first validated request;
store the first validated request in a pool comprising a plurality of validated requests;
transmit the first validated request to the practitioner communication device;
receive a selected request corresponding to one of the plurality of validated requests from the practitioner communication device;
remove the selected request from the plurality of validated requests; and
schedule the visit on a schedule of the practitioner for the selected request.

17. A system for processing claims for a plurality of patients over a communication network, the method comprising:
a practitioner communication device;
at least one server configured to:
receive a set of practitioner notes from the practitioner communication device;
extract a plurality of keywords from the set of practitioner notes;
correlate the keywords against a plurality of known keywords stored in a database;
generate one or more visit attributes based on the correlation; and
transmit the one or more visit attributes.
